(19) United States
(12) Patent Application Publication
(10) Pub. No.: US 2024/0322328 A1
(43) Pub. Date: Sep. 26, 2024

(54) Drive Battery for a Motor Vehicle and Motor Vehicle Comprising Such a Drive Battery

(71) Applicant: Bayerische Motoren Werke Aktiengesellschaft, Muenchen (DE)

(72) Inventors: Savo ASANIN, Muenchen (DE); Thomas HARSCH, Muenchen (DE); Thomas HERRMANN, Illerkirchberg (DE); Daniel MECKL, Hallbergmoos (DE); Julian PATSCHEIDER, Muenchen (DE); Stefan ULLRICH, Pfaffenhofen an der Ilm (DE)

(21) Appl. No.: 18/578,373

(22) PCT Filed: Sep. 2, 2021
(86) PCT No.: PCT/EP2021/074261

§ 371 Date: Jan. 11, 2024

(30) Foreign Application Priority Data
Jul. 23, 2021 (DE) 10 2021 119 194.7

(51) Int. Cl. H01M 50/242; B60K 1/04; H01M 10/613; H01M 10/625; H01M 50/249

(52) U.S. Cl. CPC H01M 50/242; H01M 10/625; H01M 50/249; B60K 1/04; B60K 2001/0438; B60Y 2306/01; H01M 10/613; H01M 2220/20

(57) ABSTRACT

A drive battery for a motor vehicle has a drive battery housing with a cover wall and a base wall. A battery cell layer with a plurality of battery cells and a supporting layer, which is arranged between the battery cell layer and the base wall, are arranged in the drive battery housing. The battery cell layer further has a battery cell position supporting structure which forms a collision load path in the vertical direction of the drive battery.

### BACKGROUND AND SUMMARY

The present invention relates to a drive battery for a motor vehicle with a drive battery housing.

A motor vehicle with an electric drive usually has a drive battery which has a drive battery housing in which a plurality of battery modules with battery cells, an electrical/electronics system and a cooling device are fitted. The drive battery housing is in turn fitted to a vehicle body below a floor subassembly. The known drive battery housing consists, for example, of aluminum and has lateral members, a top and a bottom. The lateral members are, for example, in the form of extruded profiles or cast parts. Further longitudinal members and crossmembers are also possibly provided in the battery housing, in order to impart a certain stiffness and collision resistance capability to the drive battery.

As disclosed in DE 10 2017 223 407 A1, a known drive battery housing has longitudinal members and a plurality of crossmembers which run between the longitudinal members. The drive battery housing also has an upper wall and a lower wall, which are each connected at least to an outer carrier structure, that is to say the outer longitudinal members and the outer crossmembers. The longitudinal members and the crossmembers are formed from extruded profiles. The drive battery housing is fitted below a body floor.

It is the object of the present invention to provide a drive battery for attachment to a floor subassembly of a motor vehicle and a motor vehicle comprising such a drive battery, wherein the drive battery has a higher power density and simultaneously a greater stiffness and strength per installation space, and wherein the drive battery has improved resistance to a collision from below.

This object is achieved by means of a drive battery and, respectively, a motor vehicle comprising such a drive battery, which have the features of the independent claims. Advantageous refinements of the invention are mentioned in the dependent claims.

According to the invention, a drive battery for a motor vehicle has a drive battery housing which has a top wall and a bottom wall. A battery cell layer with a multiplicity of battery cells and a supporting layer which is arranged between the battery cell layer and the bottom wall are arranged in the drive battery housing. The battery cell layer also has a battery cell layer support structure which forms a collision load path in a vertical direction of the drive battery.

As a result of the battery cell layer support structure, the battery cells are particularly well protected against a collision from below, i.e. a collision involving the drive battery in the vertical direction. A collision from below occurs when the motor vehicle drives over an object, for example what is known as a bollard or the like, and a ground clearance of the motor vehicle is too low. The vertical direction of the drive battery run substantially perpendicular to the individual layers of the drive battery, i.e. perpendicular to the top wall, to the bottom wall, to the supporting layer and to the battery cell layer.

The battery cells are preferably arranged vertically and next to one another. Advantageously, the battery cells are not accommodated in separate modules which are in turn accommodated in the drive battery housing. This makes it possible for more battery cells to be accommodated in the same installation space.

According to a preferred development, the battery cell layer support structure is formed between the battery cells. In the event of a collision load, the battery cell layer support structure is preferably supported in the vertical direction on the supporting layer and on the top wall.

Each constituent part of the battery cell layer support structure that adjoins a battery cell thus forms a collision load path in the vertical direction in the immediate surroundings of the battery cell. And each battery cell thus has an adjoining battery cell layer support structure. Thus, each battery cell of the battery cell layer has the same protection in the vertical direction of the drive battery. The collision load path in the vertical direction is thus present over an entire base area of the battery cell layer, since the battery cell layer support structure is formed over the entire base area, namely adjoining each battery cell.

Due to the fact that the battery cell layer support structure is supported on the supporting layer and on the top wall in the vertical direction, it is possible for the collision load to be conducted past the battery cell in the vertical direction.

The battery cell layer support structure may in particular be in the form of a multi-chamber structure, wherein in particular one battery cell is received in each chamber of the multi-chamber structure.

Such a multi-chamber structure is easy to produce and each battery cell can thus have substantially the same protection in the vertical direction of the drive battery. Each chamber wall surrounding the battery cell thus forms a collision load path in the vertical direction in the immediate surroundings of the battery cell.

Preferably, the battery cell layer support structure is formed in such a way that a collision load in the vertical direction acts only on the battery cell layer support structure and not on the battery cells. This in particular applies up to a threshold collision load up to which the battery cell layer support structure is not deformed. That is to say the collision load in the vertical direction initially does not act on the battery cells-up until a possible deformation of the battery cell layer support structure. This is in particular effected by virtue of the battery cell layer support structure being higher than the battery cells.

In this way, the supporting layer can deform in the event of a collision in the vertical direction of the drive battery and collision energy can be dissipated to protect the battery cells. The supporting layer can advantageously be supported on the stiffer battery cell layer support structure when it is being deformed in a collision energy-dissipating manner. The supporting layer can therefore also be referred to as deformation layer or collision protection layer or protection layer in the event of a bollard being driven over. The supporting layer advantageously has the function of a spacer layer, such that there is a determined distance between the battery cell layer and the bottom wall, and therefore sufficient deformation space is available in the event of a bollard being driven over or the like, i.e. in the event of the collision from below. The supporting layer may also advantageously have the function of a degassing layer, which has spaces and discharge ducts for receiving and discharging gas flowing out of the battery cells.

Preferably, the battery cell layer support structure substantially fills an intermediate space between the battery cells.

A “free” region between the battery cells, which is possibly present in any case on account of an outer shape of the battery cells, in particular in the case of circular-cylindrical battery cells, is thus used for collision load support (without using the battery cells themselves as collision load support).

Preferably, the battery cell layer support structure of the drive battery has a higher strength and/or stiffness than the battery cells. The higher strength and/or stiffness of the battery cell layer support structure is in particular in the vertical direction of the drive battery.

In this way, the battery cells per se, in particular the battery cell housing thereof, can possibly be of more lightweight embodiment, because the battery cell layer support structure can withstand the collision load instead of the battery cells.

According to a preferred development, the supporting layer is in particular plastically deformable at a lower force level than the battery cell layer support structure.

In this way, the supporting layer can advantageously be deformed by the collision load in a collision energy-dissipating manner at a predefined load level, without the battery cell layer or the battery cell layer support structure being deformed.

Preferably, the battery cell layer support structure is of single-piece form or the battery cell layer support structure at least consists of single-piece battery cell layer support structure parts which are each designed to receive a plurality of battery cells.

In this way, a number of components is low and the drive battery can be produced in a cost-effective manner.

The battery cell layer support structure advantageously has receiving spaces—referred to above as chambers—for receiving a respective battery cell. Preferably, the shape of the receiving spaces is designed to correspond to an outer shape of the battery cells. In particular, a form-fitting engagement is effected between the respective receiving space and the battery cell. The receiving spaces may also simply be in the form of passage holes in the battery cell layer support structure.

The battery cells may be pressed into the battery cell layer support structure, in particular into the above-mentioned receiving spaces.

In this way, the battery cells are correspondingly fastened in the battery cell layer support structure.

The battery cell layer support structure, in particular the above-mentioned receiving spaces, may have deformable projections which are elastically and/or plastically deformable when introducing the battery cells into the battery cell layer support structure.

In this way, the battery cells can be fastened in the battery cell layer support structure in a simple manner.

The battery cells may be glued into the battery cell layer support structure, in particular into the above-mentioned receiving spaces.

The receiving spaces of the battery cell layer support structure may also have a stop or shoulder which enables exact positioning of the battery cell.

The battery cell layer support structure may be produced from a plastic for example by extrusion, with the result that the battery cell layer support structure is lightweight and inexpensive to produce. The battery cell layer support structure may also be produced by injection molding. The battery cell layer support structure may also be formed from a fiber-reinforced plastic.

The battery cell layer support structure may also be produced from a metallic material, such as steel or aluminium, for example by extrusion. In this case, the battery cell layer support structure is also inexpensive to produce. It is potentially possible for greater collision loads to be transmitted or taken up in the case of a metallic material.

The supporting layer may be produced from a plastic, in particular a foamed plastic.

The battery cell layer support structure is advantageously designed to be congruent with respect to the supporting layer, such that the battery cell layer support structure is supportable on the supporting layer in a particularly satisfactory manner, namely over a particularly large area, in particular in the event of a collision involving the bottom wall.

This improves a collision load introduction or a collision load support on the battery cell layer support structure.

Advantageously, the bottom wall, the supporting layer, the battery cell layer, i.e. in particular the battery cell layer support structure, and the top wall are adhesively bonded to one another, in particular in a sandwich-like and large-area manner. Adhesive layers are thus arranged between the mentioned layers. A cell contacting system may also be arranged or embedded between the layers or in the layers. As a result of the sandwich-like adhesive bonding of the top wall, the battery cell layer, the supporting layer and the bottom wall to one another, the drive battery overall has a high torsional and bending stiffness, such that no further carrier construction is required within the drive battery or within the drive battery housing. All the layers of the drive battery contribute to a stiffness and strength of the drive battery. The drive battery is designed to be installed into the motor vehicle in such a way that the top wall is at the top and the bottom wall is at the bottom. In the installed state, the bottom wall thus preferably forms an undertray of the motor vehicle. Overall, the design of the drive battery including the drive battery housing and the battery constituent parts within the drive battery housing can be referred to as a sandwich composite structure—the drive battery has a sandwich design.

According to a preferred development of the present invention, a heat exchanger device for controlling the temperature of the battery cells is formed in the battery cell layer support structure.

For example, cavities or pipes for passage of a temperature-control fluid may be formed in the battery cell layer support structure.

Heat exchanger devices for controlling the temperature of the battery cells may also be formed in the top wall or in the supporting layer.

Advantageously, the battery cell layer support structure is in the form of an extruded profile with a multiplicity of passage holes for receiving the battery cells. In this case, the battery cell layer support structure for a plurality of battery cells may be of single-piece form, and a plurality of battery cell layer support structure elements may correspondingly be arranged next to one another and adjoining one another for a total base area of the battery cell layer, as a result of which the producibility of the battery cell layer support structure is simplified.

The battery cell layer support structure may also be formed from a multiplicity of support elements. The support elements may advantageously be arranged in the intermediate spaces between at least three adjoining battery cells.

Preferably, the battery cells have a circular-cylindrical cross section. In this case, the battery cells are preferably arranged upright in the battery cell layer.

Each battery cell may consist of a battery cell housing, in which a cell winding is received. The battery cell housing may consist of a cell circumferential wall, a cell bottom wall and a cell top wall.

Advantageously, the drive battery according to the invention is designed to be fitted to a floor subassembly of a body of the motor vehicle. In this case, the bottom wall may at least partially form an undertray of the motor vehicle.

Advantageously, the top wall and the bottom wall are connected to one another by a flange connection. The drive battery housing is preferably of fluid-tight embodiment.

The bottom wall and/or the top wall may be formed from aluminum or from an aluminum alloy or a steel material or a fiber-reinforced plastic.

According to a further aspect, the present invention relates to a motor vehicle, in particular a passenger motor vehicle or a heavy goods vehicle, comprising a body and comprising a drive battery according to the invention as described above, which is fitted to a floor subassembly of the body of the motor vehicle from below. The motor vehicle has an electric drive comprising the drive battery as energy store. Advantageously, the drive battery extends substantially over the entire width of the floor subassembly, i.e. substantially over the entire installation space between a left-hand longitudinal member (side sill) and a right-hand longitudinal member (side sill) of the body. The drive battery housing may also extend in a region or over the largest possible region between a front axle and a rear axle of the motor vehicle. Advantageously, the drive battery housing extends from a front end wall (of a passenger compartment) or from below the front end wall as far as front ends of a left-hand wheel arch and a right-hand wheel arch. The drive battery housing may also extend as far as below a second row of seats in the motor vehicle. In other words, the drive battery housing may extend and is arranged at least from a region between a front body pillar (an A-pillar) and a rear body pillar (in particular a C-pillar).

Advantageously, the drive battery is embodied, and connected to the body of the motor vehicle, in such a way that the drive battery increases body stiffness for driving operation of the motor vehicle and the drive battery increases body stiffness in the event that the motor vehicle is subjected to a collision load. This is made possible in particular by the sandwich-like design of the drive battery. As a result of the sandwich-like adhesive bonding of the top wall, the battery cell layer, the supporting layer and the bottom wall to one another, the drive battery overall has a high torsional and bending stiffness, such that no further carrier construction is required within the drive battery. All the layers of the drive battery contribute to a stiffness and strength of the drive battery.

Developments of the invention which are specified above can be combined with one another in any desired manner where possible and expedient.

There follows a brief description of the figures.

### BRIEF DESCRIPTION OF THE DRAWINGS

FIG. 1 schematically shows an exploded view of constituent parts of a drive battery according to one exemplary embodiment of the present invention.

FIG. 2 schematically shows a sectional view of the drive battery according to the exemplary embodiment of the present invention.

FIG. 3 schematically shows a perspective view of a part of a body of a motor vehicle, and a drive battery prior to fitting of the drive battery to the body, according to the exemplary embodiment of the present invention.

### DETAILED DESCRIPTION OF THE DRAWINGS

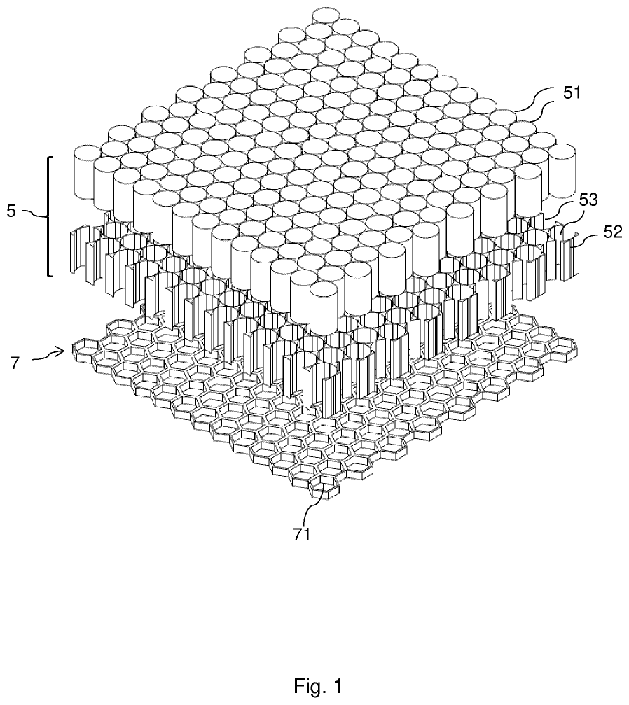

There follows a description of one exemplary embodiment of the present invention with reference to FIGS. 1 to 3.

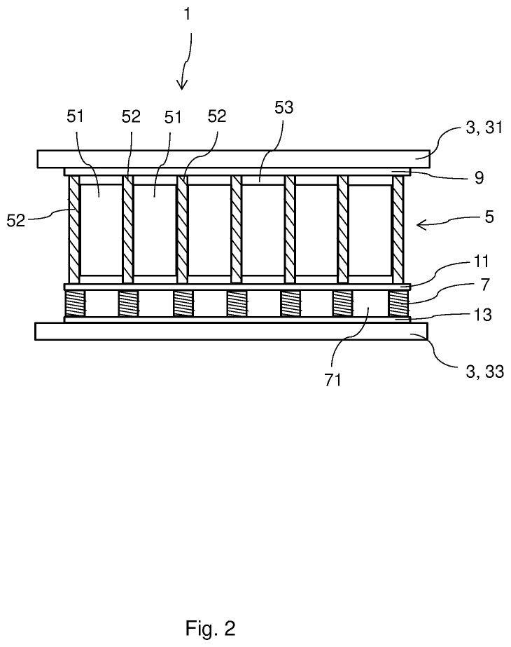

FIG. 2 shows, in highly schematic form, a partial sectional view of a drive battery 1 according to the exemplary embodiment of the present invention. The drive battery 1 is designed to be fitted to a body of a passenger motor vehicle. The drive battery 1 is what is known as a high-voltage store as energy store for driving an electric drive motor of the passenger motor vehicle. The drive battery 1 is constructed from a plurality of layers in a sandwich-like manner. Starting from the top, the drive battery 1 has a top wall 31 as part of a drive battery housing 3. The top wall 31 is connected to a top side of a battery cell layer 5 in an areal manner by way of an upper adhesive layer 9. Furthermore, a bottom side of the battery cell layer 5 is connected to a supporting layer 7 in an areal manner by way of a lower adhesive layer 11. The supporting layer 7 is in turn connected, at its bottom side, to a bottom wall 33 of the drive battery housing 3 by way of a further adhesive layer 13. The adhesive layers 9, 11, 13 are schematically depicted in continuous form in FIG. 2, wherein the adhesive layers 9 may also be designed to be congruent with respect to the end sides of the battery cell layer support structure 52 or with respect to the end sides of the supporting layer 7. The drive battery housing 3 is of course not open laterally, as illustrated in FIG. 2, but rather the top wall 31 and the bottom wall 33 are connected to one another in a fluid-tight manner by way of a flange connection 35, such that the drive battery housing 3 is of fluid-tight form. For the sake of simplicity, the adhesive layers 9, 11, 13 are illustrated in continuous form—it is of course possible for the adhesive layer to be embodied so as to be congruent with respect to the parts to be connected to one another.

The battery cell layer 5 has a multiplicity of battery cells 51. Each battery cell 51 consists of a battery cell housing composed of aluminum or steel, in which a cell winding is received. The battery cells 51 are what are known as round cells with a circular-cylindrical shape. The battery cells 51 are arranged upright, i.e. vertically, in the battery cell layer 5. The battery cell layer 5 also has a battery cell layer support structure 52. The battery cell layer support structure 52 is arranged between the battery cells 51, as shown in FIG. 2, and is higher than the battery cells 51, as is also clearly apparent from FIG. 2.

A battery cell contacting system (which is not illustrated in any more detail) is embedded in the upper adhesive layer 9 and connects the poles of the battery cells 51 to one another in a suitable manner. The adhesive surrounds conductor tracks of the battery cell contacting system. Both poles of the battery cells 51 are located on the upper end side of the battery cells 51.

Degassing openings are formed on the lower end side of the battery cells 51. Cutouts or degassing spaces 71 are formed in the supporting layer 7 so as to be complementary to the degassing openings in the battery cells 51. The cutouts may be connected to one another in a suitable manner by way of degassing ducts, such that gas escaping from a battery cell 51 can be discharged via the assigned degassing space and the degassing ducts of the supporting layer 7.

As shown in FIG. 1, the supporting layer 7 consists of a honeycomb-like structure, the basic structure of which is a cylinder with a hexagonal base area. The supporting layer 7 consists of plastic and is produced by extrusion or injection molding. The supporting layer 7 may in particular also consist of a foamed plastic. The structure of the supporting layer 7 is designed to be congruent with respect to the structure of the battery cell layer support structure 52 and is plastically deformable. In the event of a bottom collision involving the drive battery 1 installed in the motor vehicle, the bottom wall 33 together with the supporting layer 7 is possibly deformed and can thus dissipate collision energy by deformation to protect the battery cell layer 5.

FIG. 1 illustrates an exploded view of the battery cell layer 5 with the batteries 51 and the battery cell layer support structure 52 and of the supporting layer 7 without the drive battery housing 3 and without adhesive layers. As can be seen, the battery cell layer support structure 52 consists of a multi-chamber structure with a multiplicity of circular-cylindrical chambers 53 arranged next to one another, the diameter of which corresponds approximately to the diameter of a battery cell 51 and is a passage hole in this exemplary embodiment. Each chamber 53 is designed to receive a battery cell 51 and is somewhat longer than a battery cell 51. The battery cell layer support structure 52 consists of plastic and is produced by extrusion in a cost-effective manner in the present exemplary embodiment. However, the battery cell layer support structure may also be produced by injection molding. The battery cell layer support structure 52 is of single-piece form for receiving a multiplicity of battery cells 51 in a multiplicity of chambers 53 (one battery cell 51 per chamber 53). The battery cell layer support structure 52 may also consist of a plurality of single-piece battery cell layer support structure parts which are arranged laterally adjoining one another if it is not possible or is disadvantageous to produce a single-piece battery cell layer support structure 52 over an entire area of the battery cell layer 5. The battery cell layer support structure 52 fills an entire free space between the battery cells 51.

The battery cell 51 is fixed in the associated chamber 53 by adhesive bonding. As an alternative or in addition, projections in the form of ribs may be formed on an inner wall of the chamber 53 with an oversize in relation to the battery cells 51, wherein the ribs are elastically and/or plastically deformed when introducing the battery cell 51 into the chamber 53, and, as a result, the battery cell 51 is fixed in the chamber 53 similarly to an interference fit.

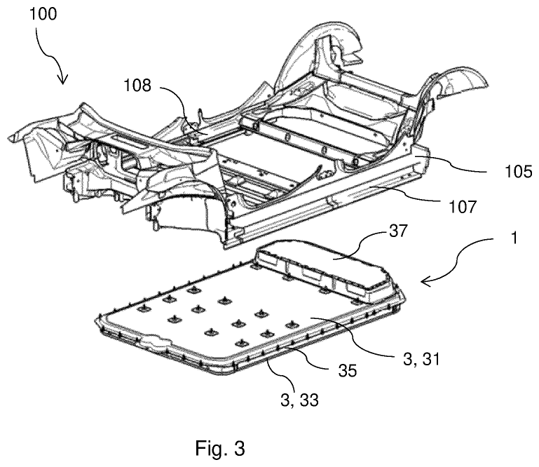

FIG. 3 shows the state prior to fitting of the drive battery 1 to a body 100. FIG. 3 does not illustrate the body 100 in full, but rather illustrates substantially only a floor subassembly 105 of the body 100. The body 100 or the floor subassembly 105 has a left-hand side sill 107 and a right-hand side sill 108, i.e. longitudinal members. The drive battery 1 has a drive battery housing 3 as described above which has substantially the same height over its entire extent—with the exception of a placed-on additional housing 37 in the rear region of the drive battery 1. The battery cell layer 5 and the supporting layer 7, which are not visible in FIG. 3, are accommodated in the drive battery housing 3. An electrical and electronics system of the drive battery 1 is for example accommodated in the additional housing 37. The drive battery 1 is fitted to the floor subassembly 105 from below by means of screw connections and possibly additionally by adhesive connections. The fitted drive energy store housing 3 forms, at least in certain portions, a floor of the floor subassembly 105 and extends over an entire width of the floor subassembly 105 between the left-hand side sill 107 and the right-hand side sill 108.

As a result of the sandwich-like design of the drive battery 1 and as a result of the adhesive bonding of the layers to one another, the drive battery 1 has a high bending and torsional stiffness. In this way, the fitted drive battery 1 can correspondingly cooperate with the floor subassembly 105 such that the motor vehicle overall has a higher bending and torsional stiffness. In other words, the above-described design means that the drive battery 1 can perform a body structure function in a particularly satisfactory manner.

A function and action of the drive battery 1 in the event of a collision is described below. As is clear from the preceding description and in particular from FIG. 3, the bottom wall 33 of the drive battery 1 forms an undertray of the motor vehicle under a passenger compartment. If the motor vehicle were to drive over an object that is higher than a ground clearance of the motor vehicle (in this respect there are standard test methods for driving over bollards), a collision force acts from below on the drive battery 1 in a vehicle vertical direction (the z direction in the vehicle coordinate system). In this case, the load path of this collision force runs from the bottom wall 33 via the supporting layer 7 to the battery cell layer support structure 52 and from the battery cell layer support structure 52 to the top wall 31. The battery cells 51 are not a constituent part of this load path (at least as long as the battery cell layer support structure 52 is not deformed). The supporting layer 7 is formed in such a way that it deforms plastically at a lower force level than the battery cell layer support structure 52. Thus, when a threshold load is exceeded, the supporting layer 7 is deformed in a collision energy-dissipating manner and is supported on the battery cell layer support structure 52, without the battery cell layer support structure 52 itself and the top wall 31 being deformed.

The battery cells 51 themselves are initially, i.e. at the beginning of a collision or as long as the battery cell layer support structure 52 itself is not deformed, not a constituent part of the collision load path, since the collision load is conducted via the battery cell layer support structure 52. In other words, the battery cells 51 are not subjected to load up to a certain collision load (i.e. until the battery cell layer support structure 52 itself is plastically deformed), and therefore the battery cells 51 are not damaged. Here, the entire intermediate space between the battery cells 51 is filled by the battery cell layer support structure and thus utilized, such that this can be used in an optimal manner to transmit the collision load.

1.-12. (canceled)

13. A drive battery for a motor vehicle, comprising:
a drive battery housing having a top wall and a bottom wall;
a battery cell layer with a multiplicity of battery cells, which multiplicity of battery cells are arranged vertically and next to one another; and
a supporting layer which is arranged between the battery cell layer and the bottom wall, wherein the battery cell layer and the supporting layer are arranged in the drive battery housing, and
the battery cell layer has a battery cell layer support structure which forms a collision load path in a vertical direction of the drive battery.

14. The drive battery according to claim 13, wherein
the battery cell layer support structure is formed between the battery cells and, in an event of a collision load, is supported in the vertical direction on the support layer and on the top wall, and
the battery cell layer support structure substantially fills an intermediate space between the battery cells.

15. The drive battery according to claim 13, wherein
the battery cell layer support structure is formed such that a collision load in the vertical direction, at a beginning of a collision, acts only on the battery cell layer support structure and not on the battery cells, and
the battery cell layer support structure extends above the battery cells.

16. The drive battery according to claim 13, wherein
the battery cell layer support structure, in the vertical direction of the drive battery, has a higher strength and/or stiffness than the battery cells.

17. The drive battery according to claim 13, wherein
the support layer is plastically deformable at a lower force level than the battery cell layer support structure.

18. The drive battery according to claim 13, wherein
the battery cell layer support structure is of single-piece form or at least consists essentially of single-piece battery cell layer support structure parts which are each configured to receive a plurality of battery cells, and
the battery cell layer support structure has receiving spaces for receiving a respective battery cell in a form-fitting manner.

19. The drive battery according to claim 13, wherein
the battery cells are pressed into the battery cell layer support structure, and/or
the battery cell layer support structure has deformable projections which are elastically and/or plastically deformable when introducing the battery cells into the battery cell layer support structure.

20. The drive battery according to claim 13, wherein the battery cells are glued into the battery cell layer support structure.

21. The drive battery according to claim 13, wherein
the battery cell layer support structure is formed from a plastic or a metallic material, and
the battery cell layer support structure is extruded.

22. The drive battery according to claim 13, further comprising:
a heat exchanger for controlling the temperature of the battery cells formed in the battery cell layer support structure.

23. The drive battery according to claim 13, wherein
the drive battery is configured for fitting to a floor subassembly of a body of the motor vehicle, wherein the bottom wall at least partially forms an undertray of the motor vehicle.

24. A motor vehicle, comprising:
a body; and
a drive battery according to claim 13,
wherein
the device battery is fitted to a floor subassembly of the body from below,
the drive battery is configured, and connected to the body of the motor vehicle, such that the drive battery increases body stiffness for driving operation of the motor vehicle, and
the drive battery increases body stiffness in an event that the motor vehicle is subjected to a collision load.
